(19) United States
(12) Patent Application Publication
(10) Pub. No.: US 2025/0389145 A1
(43) Pub. Date: Dec. 25, 2025

(54) MAGNETIC LATCH ASSIST FOR DOOR SYSTEM

(71) Applicant: Larson Manufacturing Company of South Dakota, LLC, Brookings, SD (US)

(72) Inventors: Kyle Robert Wilkinson, Concord, NC (US); Christopher Steven Smith, Sylvania, OH (US); Shaun Faust, Medina, OH (US)

(21) Appl. No.: 19/243,185

(22) Filed: Jun. 19, 2025

Related U.S. Application Data
(60) Provisional application No. 63/661,976, filed on Jun. 20, 2024.

(51) Int. Cl. E05C 19/16

(52) U.S. Cl. CPC E05C 19/16

(57) ABSTRACT

A door system includes a door frame, a door, and a latch element assembled with the door and extendable from a latch side of the door for latching engagement with a latch recess in a latch-side jamb of the door frame when the door is in a closed position. At least one door magnetic element of the door and at least one frame magnetic element of the door frame align when the door is in the unlatched nearly closed position, such that the at least one door magnetic element and the at least one frame magnetic element provide an attractive force sufficient to overcome a closure resisting force to move the door from the unlatched nearly closed position to the closed position for latching engagement of the latch element with the latch recess.

### CROSS-REFERENCE TO RELATED APPLICATION

This application claims priority to and all benefit of U.S. Provisional Patent Application Ser. No. 63/661,976, filed Jun. 20, 2024 and entitled MAGNETIC LATCH ASSIST FOR DOOR SYSTEM, the entire disclosure of which is incorporated herein by reference.

### TECHNICAL FIELD

The present disclosure is generally directed to door systems having biased closed doors, including biased closed doors having elements providing a degree of resistance to rotation of the door to the closed and latched position.

### BACKGROUND

Outward swinging entry doors, such as, for example, storm, security, and screen doors, are often provided with door closing mechanisms configured to apply a biasing force to urge the door towards a closed, latched position. Exemplary door closing mechanisms include counterweighted pulley arrangements, spring loaded hinges, and spring driven piston arrangements. The biasing or closing force applied by a conventional door closing arrangement often becomes smaller as the door nears the closed position. Further, dampening elements (e.g., hydraulic or pneumatic fluid cylinders) provided with the door closing mechanism to control the closing speed of the door (e.g., to prevent the door from slamming closed) may also reduce the closing force in the nearly closed position of the door.

Closed biasing door systems may have a variety of closure resisting elements contributing to a degree of resistance to rotation of the door to the closed and latched position. For example, some doors are latched in the closed position by a latch bolt spring biased to an extended, latching position. When the door is rotated to the closed position, a camming surface of the latch bolt is forced against a strike plate or other strike surface on the door jamb to retract or slide the latch bolt inward for alignment with, and extension into, a latch receiving recess in the door jamb. The spring biased resistance to retraction of the latch bolt may in some circumstances prevent rotation of the door to the fully closed position, for example, where the biasing or closing force applied by the door closing arrangement is insufficient at this nearly closed door position to overcome the spring force on the latch bolt. As another example, weatherstripping or other close fit engagement between the door and the door frame may provide frictional or elastically compressible resistance to full closure of the door. In some situations, biasing movement of the door (e.g., as facilitated by a door closer) from the open or partially open position may provide the momentum necessary to overcome this resistance to closing and latching of the door, but a momentum diminishing force (e.g., wind/air resistance, user intervention) may result in insufficient closing forces to overcome the closing resistance.

### SUMMARY OF THE DISCLOSURE

In an exemplary embodiment of the present disclosure, a door system includes a door frame having a vertically extending hinge-side jamb, a vertically extending latch-side jamb, a horizontally extending upper head, and a horizontally extending lower sill, and a door having a vertically extending hinge side hingedly attached to the hinge-side jamb, a vertically extending latch side abutting the latch-side jamb when the door is in a closed position, a horizontally extending top end abutting the upper head when the door is in the closed position, and a horizontally extending bottom end abutting the lower sill when the door is in the closed position. A latch element is assembled with the door and extendable from the latch side of the door for latching engagement with a latch recess in the latch-side jamb when the door is in the closed position. When the door is in an unlatched nearly closed position, the door is subjected to a closure resisting force to resist movement of the door to the closed position. The door includes at least one door magnetic element and the door frame includes at least one frame magnetic element for alignment with the at least one door magnetic element when the door is in the unlatched nearly closed position. The at least one door magnetic element and the at least one frame magnetic element provide an attractive force sufficient to overcome the closure resisting force to move the door from the unlatched nearly closed position to the closed position for latching engagement of the latch element with the latch recess.

In another exemplary embodiment of the present disclosure, a door system includes a door frame having a vertically extending hinge-side jamb, a vertically extending latch-side jamb, a horizontally extending upper head, and a horizontally extending lower sill, and a door having a vertically extending hinge side hingedly attached to the hinge-side jamb, a vertically extending latch side abutting the latch-side jamb when the door is in a closed position, a horizontally extending top end abutting the upper head when the door is in the closed position, and a horizontally extending bottom end abutting the lower sill when the door is in the closed position. A latch element is assembled with the door and extendable from the latch side of the door for latching engagement with a latch recess in the latch-side jamb when the door is in the closed position. The door includes at least first and second door magnetic element disposed on at least one of the top end, the bottom end, and the latch side at smaller first and greater second lateral distances from the hinge side, and the door frame includes at least first and second frame magnetic element disposed on corresponding ones of the upper head. the lower sill, and the latch-side jamb for alignment with the first and second door magnetic elements at least when the door is in the closed position. When the door is in a first, partially open position, the first door and frame magnetic elements apply a first magnetic attractive force to assist rotation of the door towards an unlatched, nearly closed position. When the door is in the unlatched, nearly closed position, each of the at least first and second door and frame magnetic elements apply a combined magnetic attractive force to cause the door to move from the unlatched, nearly closed position to the closed position.

### BRIEF DESCRIPTION OF THE DRAWINGS

Further features and advantages of the invention will become apparent from the following detailed description made with reference to the accompanying drawings, wherein:

FIG. 1 is a perspective view of an exemplary door system;

FIG. 2 is an upper cross-sectional view of a latching mechanism for an exemplary door system;

FIG. 3A is a schematic front view of a door system, according to an exemplary aspect of the present disclosure;

FIG. 3B is a schematic upper cross-sectional view of the door system of FIG. 3A, shown with the door in an unlatched, nearly closed position;

FIG. 3C is a schematic upper cross-sectional view of the door system of FIG. 3A, shown with the door in a closed position;

FIG. 4 is a schematic partial side cross-sectional view of abutting door and door frame portions of a door system, according to an exemplary aspect of the present disclosure;

FIG. 4A is a partial side cross-sectional view of abutting door and door frame portions of a door system, according to an exemplary aspect of the present disclosure;

FIG. 4B is a partial side cross-sectional view of abutting door and door frame portions of another door system, according to an exemplary aspect of the present disclosure;

FIG. 4C is a partial side cross-sectional view of abutting door and door frame portions of another door system, according to an exemplary aspect of the present disclosure;

FIG. 5 is a schematic partial side cross-sectional view of abutting door and door frame portions of a door system, according to an exemplary aspect of the present disclosure;

FIG. 5A is a partial side cross-sectional view of abutting door and door frame portions of a door system, according to an exemplary aspect of the present disclosure;

FIG. 5B is a partial side cross-sectional view of abutting door and door frame portions of another door system, according to an exemplary aspect of the present disclosure;

FIG. 5C is a partial side cross-sectional view of abutting door and door frame portions of another door system, according to an exemplary aspect of the present disclosure;

FIG. 5D is a partial side cross-sectional view of abutting door and door frame portions of another door system, according to an exemplary aspect of the present disclosure;

FIG. 6 is a perspective view of first and second magnetic elements for installation with a door system, according to an exemplary aspect of the present disclosure;

FIG. 6A is an exploded perspective view of the first and second magnetic elements of FIG. 6;

FIG. 7 is a perspective view of first and second magnetic elements for installation with a door system, according to an exemplary aspect of the present disclosure;

FIG. 7A is an exploded perspective view of the first and second magnetic elements of FIG. 7;

FIG. 8 is a perspective view of first and second magnetic elements for installation with a door system, according to an exemplary aspect of the present disclosure;

FIG. 8A is an exploded perspective view of the first and second magnetic elements of FIG. 8;

FIG. 9 is a perspective view of first and second magnetic elements for installation with a door system, according to an exemplary aspect of the present disclosure;

FIG. 9A is an exploded perspective view of the first and second magnetic elements of FIG. 9;

FIGS. 10 and 10A are perspective and partially exploded perspective views of first and second magnetic elements for installation with a door system, according to an exemplary aspect of the present disclosure;

FIG. 11 is a perspective view of magnetic elements for installation with a door system, according to an exemplary aspect of the present disclosure;

FIG. 12 is a side view of first and second magnetic elements for installation with a door system, according to an exemplary aspect of the present disclosure;

FIG. 13 is a side view of first and second magnetic elements for installation with a door system, according to an exemplary aspect of the present disclosure;

FIG. 14 is a side view of a door mounting arrangement for a magnetic element, according to an exemplary aspect of the present disclosure;

FIG. 15A is a schematic front view of another door system, according to an exemplary aspect of the present disclosure;

FIG. 15B is a schematic upper cross-sectional view of the door system of FIG. 15A, shown with the door in a partially open position;

FIG. 15C is a schematic upper cross-sectional view of the door system of FIG. 15A, shown with the door in an unlatched, nearly closed position;

FIG. 15D is a schematic upper cross-sectional view of the door system of FIG. 15A, shown with the door in a closed position;

FIG. 16 is a schematic front view of another door system, according to an exemplary aspect of the present disclosure;

FIG. 17 is a schematic front view of another door system, according to an exemplary aspect of the present disclosure;

FIG. 18 is a schematic front view of another door system, according to an exemplary aspect of the present disclosure;

FIG. 19 is a front view of a door system, according to an exemplary aspect of the present disclosure;

FIG. 19A is an enlarged perspective view of a portion of the door system of FIG. 19;

FIG. 20 is a schematic upper cross-sectional partial view of another door system, according to an exemplary aspect of the present disclosure; and

FIG. 21 is a perspective view of a door closer for a door system, according to an exemplary aspect of the present disclosure;

### DETAILED DESCRIPTION

This Detailed Description merely describes exemplary embodiments and is not intended to limit the scope of the claims in any way. Indeed, the invention as claimed is broader than and unlimited by the described embodiments, and the terms used have their full ordinary meaning.

The present disclosure contemplates arrangements for assisting or ensuring full closure and latching of a door in a door system, such that the door does not remain in an unlatched, nearly closed position, for example, due to closure resisting forces of, for example, a door latch mechanism (e.g., a spring loaded latch bolt), dampening door closer, compressible weatherstripping, and/or air pressure between the door and a second (e.g., entry) door.

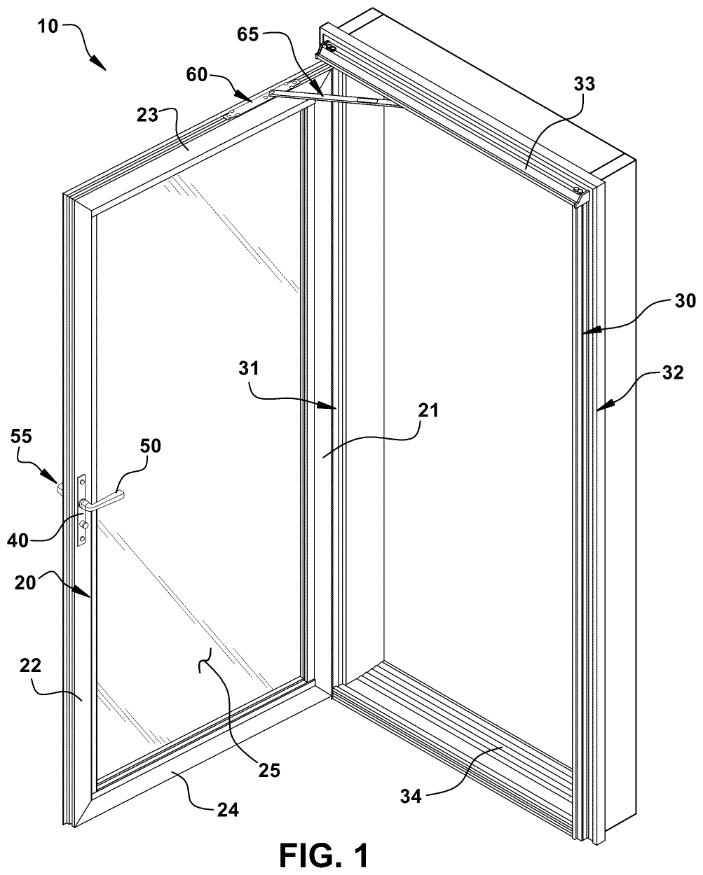

With reference to FIG. 1, an exemplary door system 10 includes a door 20 installed in a door frame 30. The door frame 30 includes a vertically or longitudinally extending hinge-side jamb 31, a vertically or longitudinally extending latch-side jamb 32, a horizontally or laterally extending upper head 33, and a horizontally or laterally extending lower sill 34. The door 20 includes a vertically or longitudinally extending hinge side 21 hingedly or pivotably attached to the hinge side jamb 31 (e.g., by one or more hinge assemblies) for rotation of the door in a transverse direction between open and closed positions, and a vertically or longitudinally extending latch side 22 carrying a latching mechanism 40 for latching engagement with the latch-side jamb 32 when the door is in the closed position within the door frame 30. In the closed position, a horizontally or laterally extending top end 23 of the door 20 abuts the upper head 33 and a horizontally or laterally extending bottom end 24 of the door abuts the lower sill 34.

The door 20 can be any of a variety of types of doors, such as, for example, a storm door (e.g., including a transparent panel 25, as shown), a screen door, a security screen door, a configurable door with an interchangeable portion, a security door with bars, and a security door with laminated glass. The door 20 can be a residential door, a light commercial door, or a heavy commercial door, among other types of doors.

The door 20 can be provided with a handle 50. The handle 50 can actuate the latch mechanism 40, and may, but need not, further actuate a lockset 55 providing additional security against unauthorized entry. As shown, the handle 50 is a lever-style handle, but a door knob or any other type of handle or mechanism can optionally be substituted in place of the illustrated lever-style handle 50.

The door 20 may additionally be provided with door closer hardware, including a door closer 60 with a closer arm 65. The closer arm 65 can be a single-segment closer arm or a multi-segment closer arm in various embodiments. The door closer 60 may include a dampening element (not shown), for example, hydraulic or pneumatic fluid cylinders, to dampen the closing force and slow the closing speed of the door 20. In some embodiments, closer hardware is as described in one or more of the following U.S. patent publications, which are incorporated herein by reference in there entireties: U.S. Pat. Nos. 10,774,570, 10,801,241, and 10,995,534.

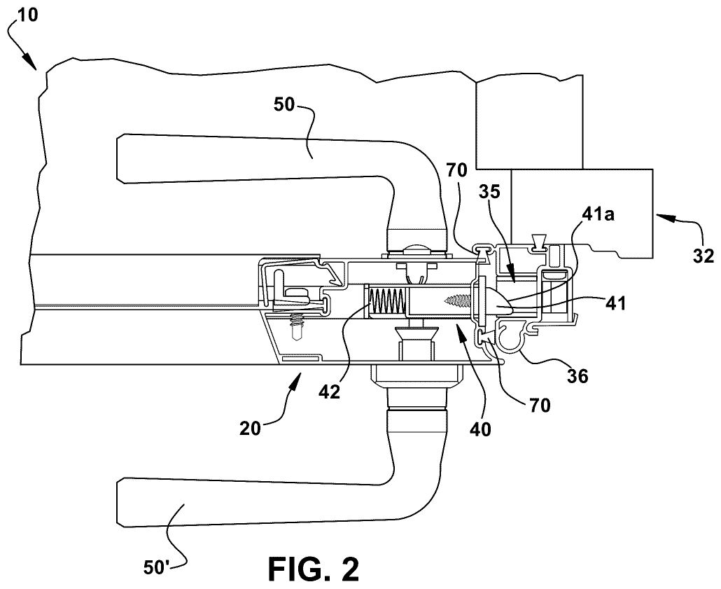

FIG. 2 is a partial upper cross-sectional view of a door system 10 including an exemplary latching mechanism 40, for example, for use with the door system 10 illustrated in FIG. 1. As shown, the latch mechanism 40 includes a latch bolt 41 that is laterally extendable, by a biasing spring 42 within the door 20, into a strike channel or latch recess 35 in the latch-side jamb 32. As shown, there are two handles 50, 50′ connected to the latch mechanism 40 within the door 20. The latch bolt 41 can be configured to be actuated as a part of a lockset 55, and turning or pulling an outer handle 50′ can retract the latch bolt 41 when the lockset 55 is in an unlocked state, or if a user is operating the inner handle 50 to open the door 20 from the inside. A rear edge surface 41a of the latch bolt 41 is tapered such that when the door 20 is rotated to the closed position (e.g., by an external, user applied closing force, or by a closing force provided by the door closer 60), engaging forces of the rear edge surface against a strike surface 36 of the latch-side jamb 32, forward of the latch recess 35, causes the latch bolt 41 to retract against the biasing spring 42 for movement of the latch bolt past the strike surface and into alignment with and extension into the latch recess. The force of the biasing spring 42 against the latch bolt 41 may provide a degree of resistance to rotation of the door 20 to the closed and latched position when the door reaches an unlatched nearly closed position in which the latch bolt rear edge surface 41a engages or contacts the strike surface 36.

The spring loaded latch bolt 41 is just one example of a closure resisting element of a door system that may provide a degree of resistance to rotation of the door to the closed and latched position within the door frame 30. One or more other closure resisting elements may additionally or alternatively be present. For example, either or both of the door 20 and the door frame may include flexible and/or compressible weatherstripping 70, which may provide frictional and/or elastic resistance to movement of the door 20 to the closed position. Additional or alternative latching mechanisms, weatherstripping, and/or frictional contacting surfaces of the door and door frame may be provided with, or inherent in, the door system.

According to an exemplary aspect of the present disclosure, the door and the door frame may each be provided with one or more magnetic elements that align with each other when the door is in the unlatched nearly closed position, such that the magnetic elements of the door and the door frame provide an attractive force sufficient to overcome the resisting force of the latch mechanism, weather stripping, and/or any other closure resisting element to move the door from the unlatched nearly closed position to the closed position. In some embodiments, one or more door magnetic elements may be positioned on outer peripheral portions of the door, and one or more frame magnetic elements may be positioned on the door frame at locations selected to align with the one or more door magnetic elements when the door is in the unlatched, nearly closed position.

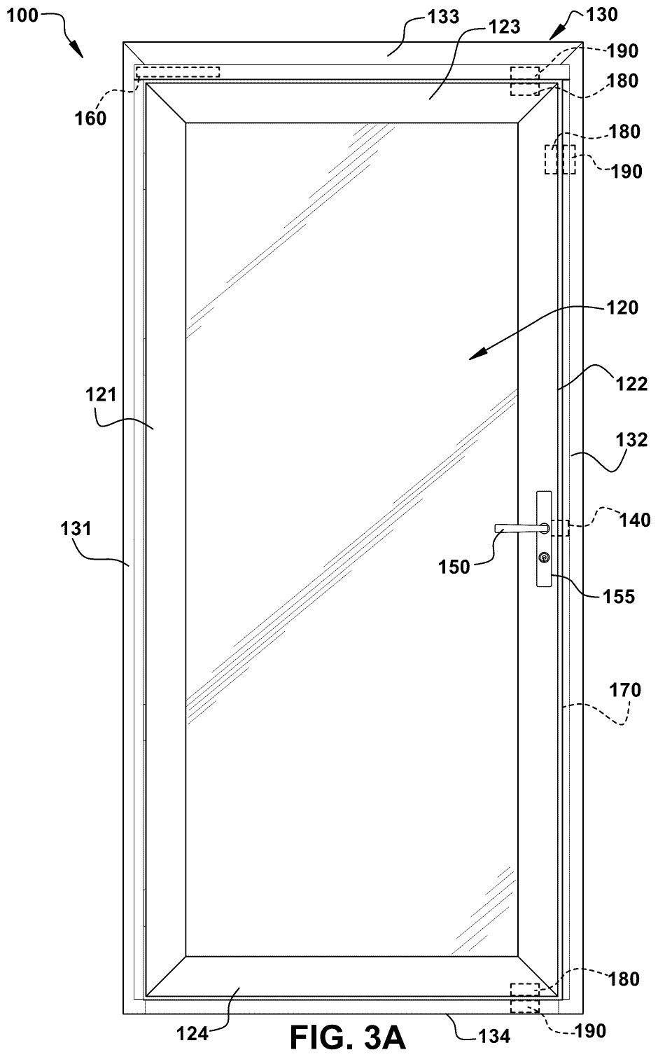

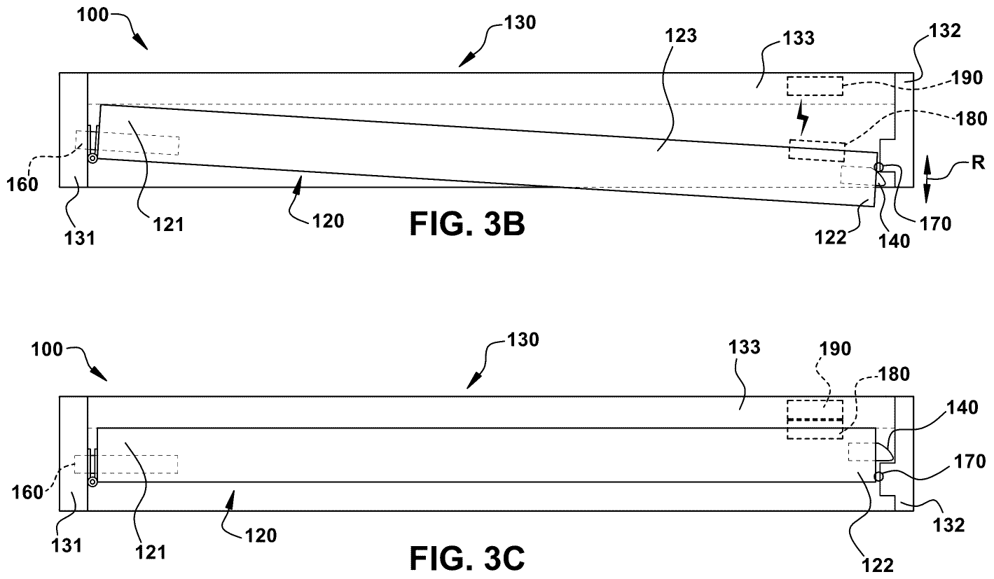

FIGS. 3A, 3B, and 3C schematically illustrate front and cross-sectional upper views of a door system 100 including a door 120 installed in a door frame 130, which may be similar to the door system 10 illustrated in FIGS. 1 and 2 and described above. The door frame 130 includes a vertically extending hinge-side jamb 131, a vertically extending latch-side jamb 132, a horizontally extending upper head 133, and a horizontally extending lower sill 134. The door 120 includes horizontally extending top and bottom ends 123, 124, a vertically extending hinge side 121 hingedly or pivotably attached to the hinge-side jamb 131 (e.g., by one or more hinge assemblies), and a vertically extending latch side 122 carrying a latching mechanism 140 for latching engagement with the latch-side jamb 132 when the door is in a closed position within the door frame 130. In the closed position, the top end 123 of the door 120 abuts the upper head 133 and the bottom end 124 of the door abuts the lower sill 134.

The door system 100 of FIGS. 3A-3C may include a latching mechanism 140, one or more weatherstripping elements 170, one or more handles 150, one or more locksets 155, and one or more door closers 160, which may, but need not, be similar to the components of the door system 10 illustrated in FIGS. 1 and 2 and described above.

As shown in FIG. 3A, the door 120 includes a door magnetic element 180 disposed on or secured to one of the latch side 122, the top end 123, and the bottom end 124, and the door frame 130 includes a frame magnetic element 190 disposed on or secured to a corresponding one of the latch-side jamb 132, the upper head 133, and the lower sill 134. When the door 120 is in the unlatched, nearly closed position (FIG. 3B), the door and frame magnetic elements 180, 190 align and are in sufficient proximity (e.g., within about 1-2 inches) to provide a magnetic attractive force M sufficient to overcome a resisting force R of at least one closure resisting element (e.g., spring-loaded latch 140, and/or weatherstripping 170) to move the door 120 from the unlatched nearly closed position to the closed position (FIG. 3C).

While the door magnetic element 180, when provided on one of the top and bottom ends 123, 124 of the door 120, may be positioned at any suitable location along the lateral width of the door, in some embodiments, the door and frame magnetic elements are positioned closer to the latch side 122 of the door so that the magnetic attractive force M is applied at a greater distance from the hinge or fulcrum to provide a greater force load against the resisting force(s) R. As an additional or alternative consideration, in some embodiments, the door and frame magnetic elements 180, 190 may be positioned further from the latch side 122 of the door 120 so that the door and frame magnetic elements are in closer proximity to each other when the door is in the unlatched, nearly closed position.

The magnetic elements described herein may include a wide variety of arrangements, and may be selected to have a sufficient magnetic attractive strength, for example, a pull force between about 4 lbs and about 5 lbs, or up to about 11 lbs. In some embodiments, the door and frame magnetic elements both include magnets (e.g., neodymium magnets, alnico magnets, ferrite magnets, samarium-cobalt magnets, electromagnets), with opposite polarity surfaces facing each other for magnetic attraction. In other embodiments, one of the door and frame magnetic elements includes a magnet and the other of the door and frame magnetic elements includes a ferromagnetic material (e.g., iron, iron alloys, nickel, nickel alloys, cobalt, and/or cobalt alloys). In some embodiments, either or both of the door and frame magnetic elements may include a magnet secured or stacked over a metal plate configured to increase a strength of a magnetic flux or attachment force acting through the magnet. Exemplary metal plates may include, for example, iron, steel, or other ferromagnetic materials.

In some embodiments, the facing, attracting surfaces of the first and second magnetic elements may extend in a transverse direction, such that the first and second magnetic elements move into sliding abutment with each other as the door is transversely rotated from the open position to the nearly closed position to the closed and latched position.

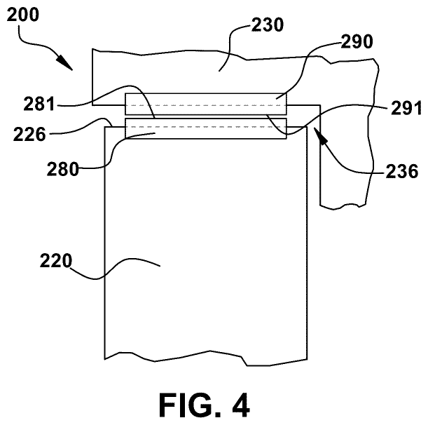

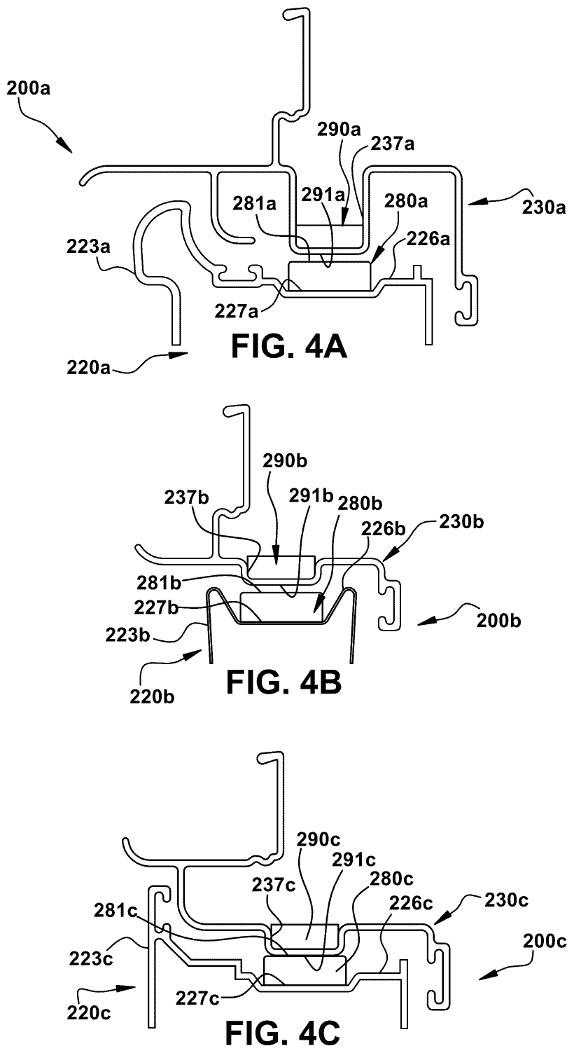

FIG. 4 schematically illustrates a cross-sectional view of a magnetic element carrying portion of a door system 200 having a door 220 with an edge portion 226 (e.g., on the latch side, top end, or bottom end of the door) carrying a first magnetic element 280 and a door frame 230 with a door abutting portion 236 (e.g., on the corresponding latch-side jamb, upper head, or lower sill of the door frame) carrying a second magnetic element 290, such that facing, attracting surfaces 281, 291 extend in a transverse direction (i.e., normal to the doorway or in the general direction of movement of the door). As the door 220 is transversely rotated from the open position to the nearly closed position to the closed and latched position, the first and second magnetic elements 280, 290 move into sliding, facing abutment with each other for magnetic attraction of the facing attracting surfaces 281, 291.

Many different tranverse magnetic surface arrangements may be utilized. For example, FIGS. 4A, 4B, and 4C illustrates cross-sectional views of magnetic element carrying portions of door systems 200a-c each having a door 220a-c with an edge portion 226a-c (e.g., on the top end 223a-c, as shown) carrying a first magnetic element 280a-c and a door frame 230a-c with a door abutting portion 236a-c (e.g., on the corresponding upper head 233a-c, as shown) carrying a second magnetic element 290a-c, such that facing, attracting surfaces 281a-c, 291a-c extend in a transverse direction. As shown, the first magnetic element 280a-c may be seated in an external recessed portion 227a-c of the edge portion 226a-c, and the second magnetic element 290a-c may be disposed within an internal channel 237a-c of the door abutting portion 236a-c. In other embodiments (not shown), the first magnetic element may be disposed within an internal channel or cavity in the door edge portion, and/or the second magnetic element may be seated in an external recessed portion of the door frame's door abutting portion.

In some embodiments, the facing, attracting surfaces of the first and second magnetic elements may extend in a longitudinal and/or lateral direction, such that the first and second magnetic elements move into facing abutment with each other as the door is transversely rotated from the open position to the nearly closed position to the closed and latched position.

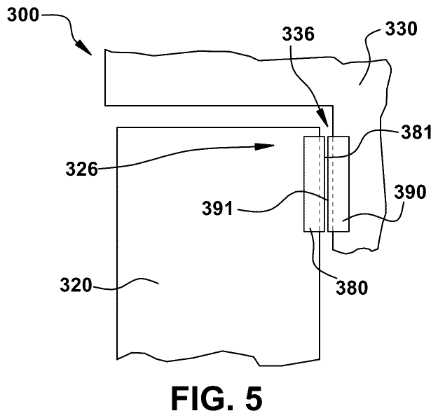

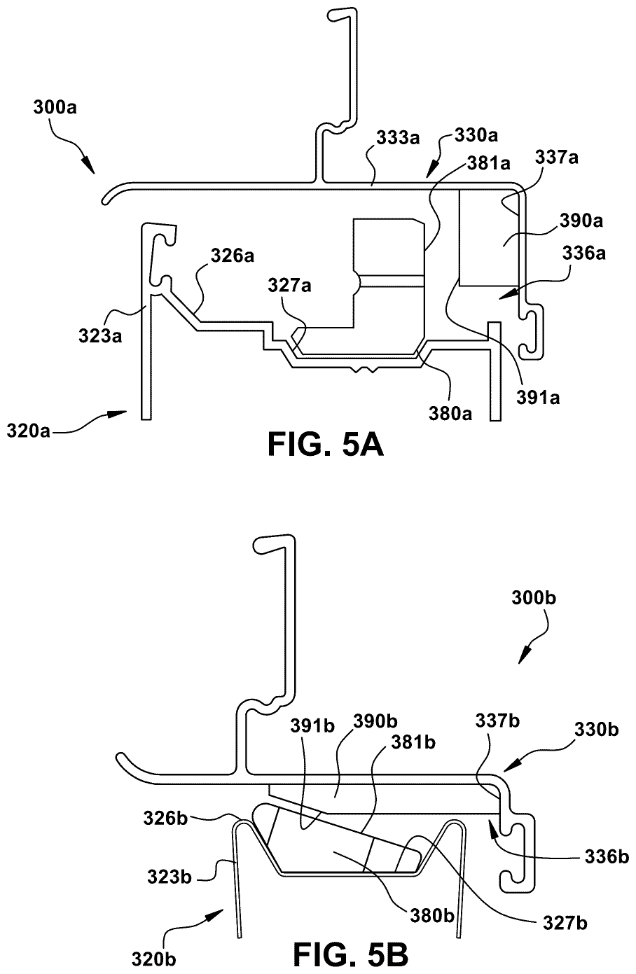

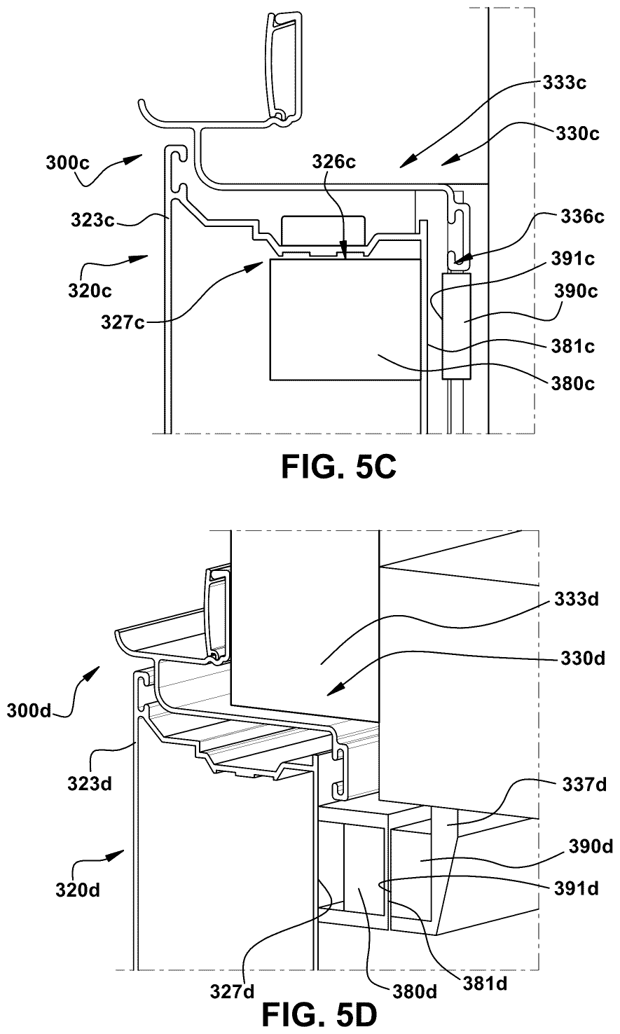

FIG. 5 schematically illustrates a cross-sectional view of a magnetic element carrying portion of a door system 300 having a door 320 with an edge portion 226 (e.g., on the latch side, top end, or bottom end of the door) carrying a first magnetic element 380 and a door frame 330 with a door abutting portion 336 (e.g., on the corresponding latch-side jamb, upper head, or lower sill of the door frame) carrying a second magnetic element 390, such that facing, attracting surfaces 381, 391 extend in a lateral and our longitudinal direct direction (i.e., parallel to the doorway or normal to the general direction of movement of the door). As the door 320 is transversely rotated from the open position to the nearly closed position to the closed and latched position, the first and second magnetic elements 380, 390 move into facing abutment with each other for magnetic attraction of the facing attracting surfaces 381, 391.

Many different lateral/longitudinal magnetic surface arrangements may be utilized. For example, FIGS. 5A, 5B, 5C, and 5D illustrates cross-sectional views of magnetic element carrying portions of door systems 300a-d each having a door 320a-d with an edge portion 326a-d (e.g., on the top end 323a-d, as shown) carrying a first magnetic element 380a-c and a door frame 330a-d with a door abutting portion 336a-d (e.g., on the corresponding upper head 333a-d, as shown) carrying a second magnetic element 390a-d, such that facing, attracting surfaces 381a, 391a extend in a longitudinal direction.

As shown in FIG. 5A, the first magnetic element 380a may be seated in an external recessed portion 327a of the edge portion 326a, with the attracting surface 381a extending above the door edge, and the second magnetic element 390a may be seated in an inner shoulder portion 337a of the door abutting portion 336a, with the attracting surface 391a facing the first magnetic element attracting surface 381a.

As shown in FIG. 5B, the first magnetic element 380a may be seated in an external recessed portion 327b of the edge portion 326b, with a tapered attracting surface 381b extending above the door edge, and the second magnetic element 390b may be seated in an inner shoulder portion 337b of the door abutting portion 336b, with a tapered attracting surface 391b aligned with and complementarily shaped to the tapered attracting surface 381b of the first magnetic element, for example, to provide a lower profile abutment between the first and second magnetic elements.

As shown in FIG. 5C, the first magnetic element 380c may be retained in an internal cavity 327c of the door 320c at the edge portion 326c, with the attracting surface 381c abutting the door skin, and the second magnetic element 390c may be secured to the door abutting portion 336c of the door frame 330c, with the attracting surface 391c facing the first magnetic element attracting surface 381c.

As shown in FIG. 5D, the first magnetic element 380d may be attached to a rear face 327d of the door 320d at the edge portion 326d, and the second magnetic element 390d may be provided on a downward extending flange portion 337d of the door frame 330d.

In other embodiments (not shown), the magnetic element attaching arrangements of FIGS. 5A-5D may be used with each other, or with other such arrangements, in a variety of other combinations.

In some embodiments, a magnetic element (e.g., a magnet or ferromagnetic component) may be embedded in or enclosed within a cavity of the door (e.g., as shown in FIG. 5C) or the door frame (e.g., as shown in FIGS. 4A, 4B, and 4C), for example, to protect the magnetic element(s) from moisture and corrosion. In other embodiments, a magnetic element may be secured to an exterior surface of the door (e.g., as shown in FIGS. 4A, 4B, 4C, and 5A) or the door frame (e.g., as shown in FIGS. 5A and 5B). In such arrangements, the magnetic elements may be coated for corrosion resistance with a suitable coating or plating, such as, for example, galvanic nickel (NiCuNi) plating, or zinc (Zn) plating. In other arrangements, the magnetic elements may be sheathed or over-molded with a suitable plastic or elastomeric material for protection from corrosive environments.

In still other embodiments, the magnetic elements may include one or more housing components enclosing the magnet to prevent exposure to moisture or other corrosive elements. The housing components may be adapted to be attached (e.g., using screws or other fasteners) to the door and/or door frame. The housing may be provided in any suitable material, including, for example, glass fiber reinforced polyamide (e.g., 33% glass fiber reinforced polyamide 66 (PA66-GF33)).

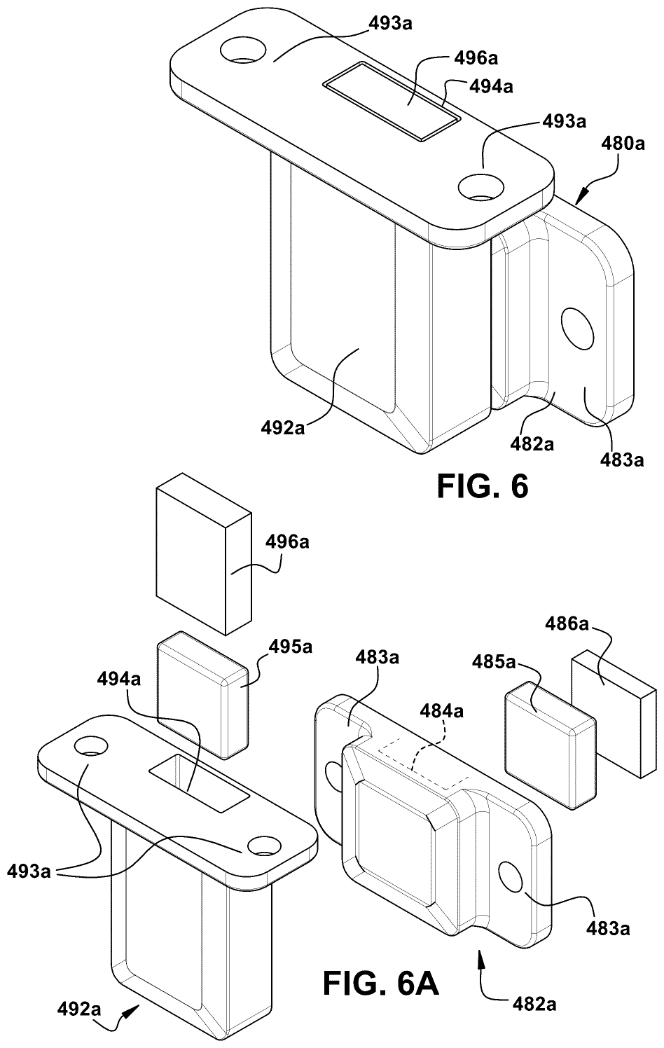

FIGS. 6 and 6A illustrate exemplary first and second magnetic elements 480a, 490a including first and second exterior housings 482a, 492a and first and second interior magnets 485a, 495a. In the illustrated example, the first exterior housing 482a is a flush mount housing, for example, for attachment to a rear surface of the door (e.g., at the top end of the door), by installing fasteners (not shown) through apertured side portions 483a of the housing, to enclose the magnet 485a within a transverse recess or cavity 484a within the housing and sealed against the door rear surface. The exemplary second exterior housing 492a is a flange mount housing, for example, for attachment to a bottom surface of the door frame upper head, by installing fasteners through apertured side flange portions 493a of the housing, to enclose the magnet 495a within a longitudinal recess or cavity 494a within the housing and sealed against the upper head bottom surface. As shown, compressible (e.g., foam) blocking 486a, 496a may be installed over the magnets 485a, 495a to stabilize the free-floating magnet and/or to act as a barrier between the housing 482a, 492a and the corresponding mounting surface.

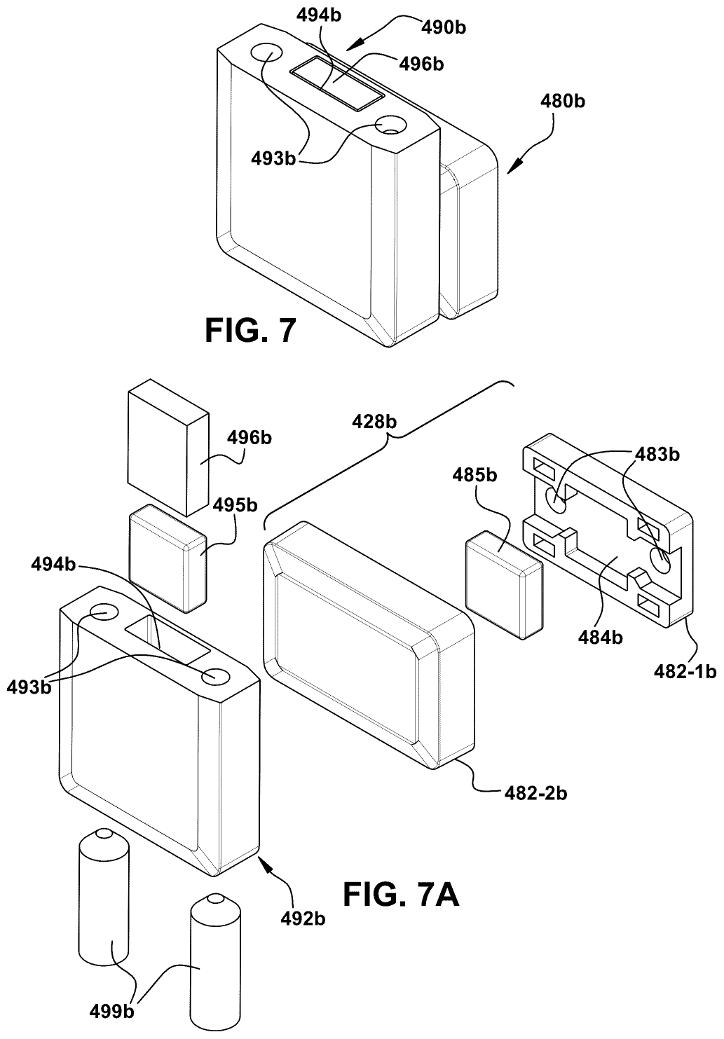

FIGS. 7 and 7A illustrate exemplary first and second magnetic elements 480b, 490b including first and second exterior housings 482b, 492b and first and second interior magnets 485b, 495b. In the illustrated example, the first exterior housing 482b is a two piece flush mount housing, for example, for attachment to a rear surface of the door (e.g., at the top end of the door), by installing fasteners (not shown) through apertured side portions 483b of a base portion 482-1b of the housing, which is enclosed by a snap-fit cover portion 482-2b of the housing to cover the fasteners and enclose the magnet 485b within a transverse recess or seat portion 484b within the housing, and sealed against the door rear surface. The exemplary second exterior housing 492b is an end mounted housing, for example, for attachment to a bottom surface of the door frame upper head, by installing fasteners 499b through apertured side portions 493b of the housing, to enclose the magnet 495b within a longitudinal recess or cavity 494b within the housing and sealed against the upper head bottom surface. As shown, compressible (e.g., foam) blocking 496b may be installed over the magnet 495b to stabilize the free-floating magnet and/or to act as a barrier between the housing 492b and the corresponding mounting surface.

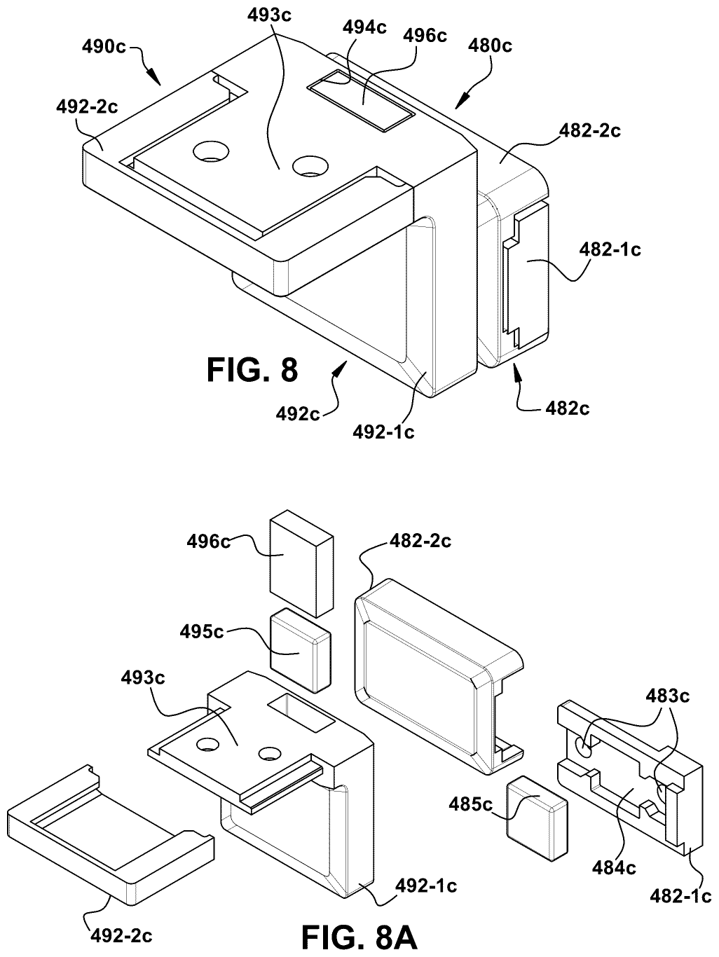

FIGS. 8 and 8A illustrate exemplary first and second magnetic elements 480c, 490c including first and second exterior housings 482c, 492c and first and second interior magnets 485c, 495c. In the illustrated example, the first exterior housing 482c is a two piece flush mount housing, for example, for attachment to a rear surface of the door (e.g., at the top end of the door), by installing fasteners (not shown) through apertured side portions 483c of a base portion 482-1c of the housing, which is enclosed by a slide-fit cover portion 482-2c of the housing to cover the fasteners and enclose the magnet 485c within a transverse recess or seat portion 484c within the housing, and sealed against the door rear surface. The exemplary second exterior housing 492c is a two-piece flange mounted housing, for example, for attachment to a bottom surface of the door frame upper head, by installing fasteners through an apertured flange portion 493c of a base housing portion 492-1c, to enclose the magnet 495c within a longitudinal recess or cavity 494c within the housing and sealed against the upper head bottom surface. As shown, compressible (e.g., foam) blocking 496c may be installed over the magnet 495c to stabilize the free-floating magnet and/or to act as a barrier between the housing 492c and the corresponding mounting surface. A cover portion 492-2c of the housing 492c may slide over the flange portion 493c to cover the fasteners.

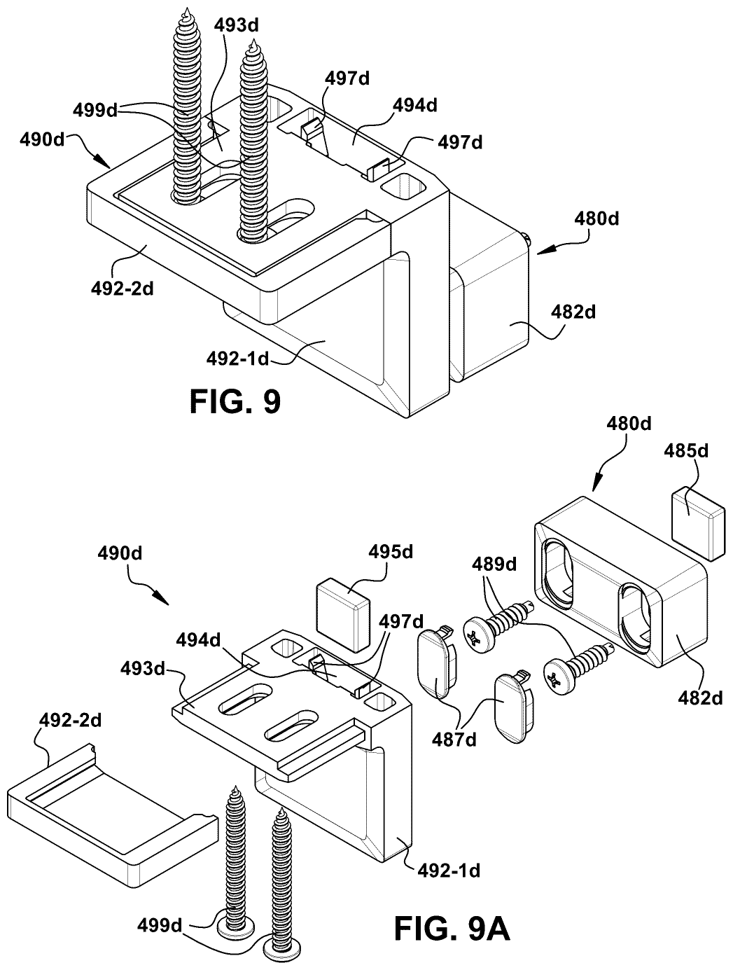

FIGS. 9 and 9A illustrate exemplary first and second magnetic elements 480d, 490d including first and second exterior housings 482d, 492d and first and second interior magnets 485d, 495d. In the illustrated example, the first exterior housing 482d is a one piece flush mount housing, for example, for sealing attachment (e.g., using a gasket seal, not shown) to a rear surface of the door (e.g., at the top end of the door), by installing fasteners 489d through apertured side portions 483d of the housing, which are covered by snap-in panels 487d, and sealed against the door rear surface. The exemplary second exterior housing 492d is a two-piece flange mounted housing, for example, for sealing attachment (e.g., using a gasket seal, not shown) to a bottom surface of the door frame upper head, by installing fasteners 499d through an apertured flange portion 493d of a base housing portion 492-1d, to enclose the magnet 495d within a longitudinal recess or cavity 494d within the housing and sealed against the upper head bottom surface. As shown, the base housing portion 492-1d may include flexible resilient fingers 497d in the cavity 494d for positioning retention of the magnet 495d. A cover portion 492-2d of the housing 492d may slide over the flange portion 493d to cover the fasteners.

According to another exemplary aspect of the present disclosure, the first and second magnetic elements may be provided with housing adapted or adaptable to accommodate varying door and door frame dimensions. For example, FIGS. 10 and 10A illustrate a second (frame) magnetic element 490e having a flanged housing 492e provided with one or more spacers 498e installed between the flange 493e and the door frame (not shown) to adjust the position of the frame magnet (not shown) with respect to the door and the door frame).

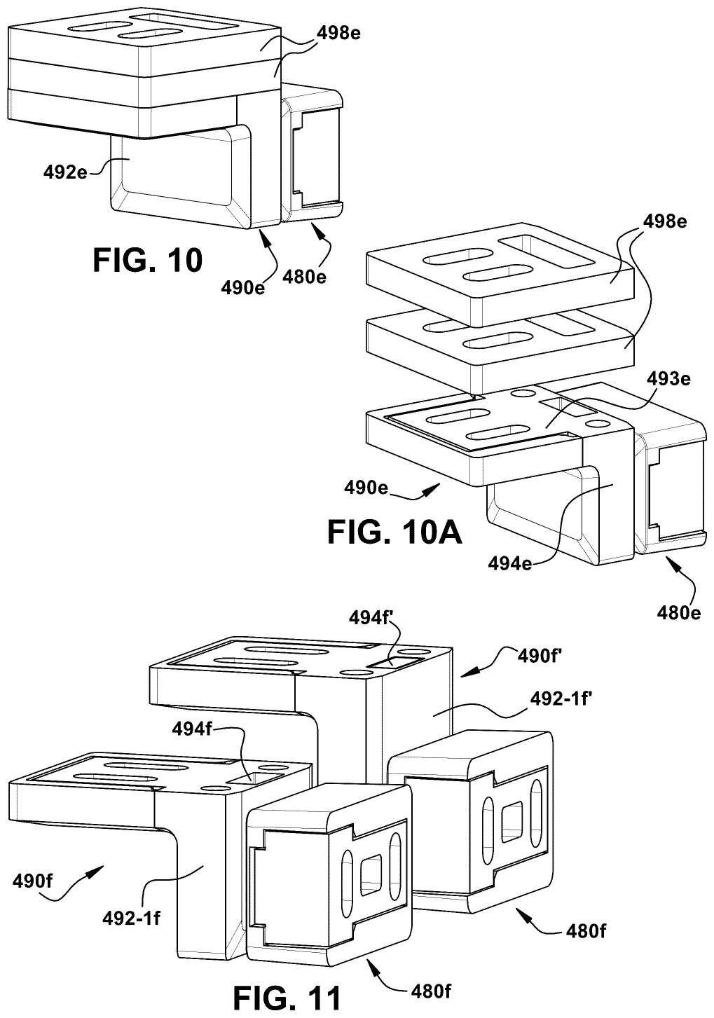

As another example, as shown in FIG. 11, frame magnetic elements 490f, 490f′ may be provided with base housing portions 492-1f, 492-1f′ having different lengths, with magnet receiving cavities 493f, 493f′ of different lengths for desired positioning of the frame magnets (not shown).

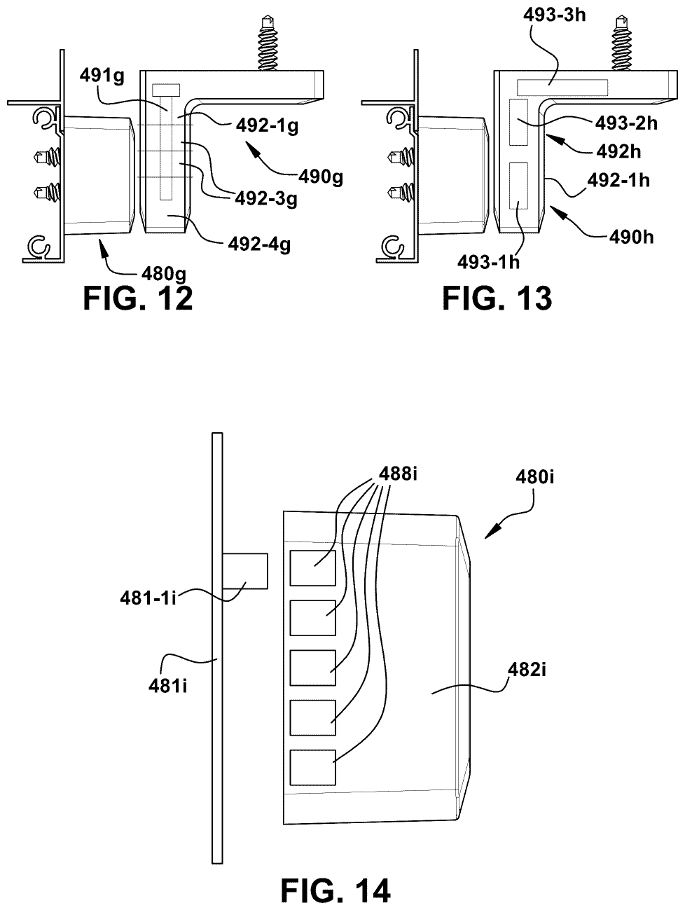

As another example, as shown in FIG. 12, a frame magnetic element 490g may be provided with a base housing portion 492-1g assembled with one or more spacer housing sections 492-3g, 492-4g (joined, for example, by one or more threaded fasteners 491g), for positioning of the magnet receiving cavity and magnet (not shown).

As another example, as shown in FIG. 13, a frame magnetic element 490h may be provided with a base housing portion 492-1h having a plurality of magnet receiving cavities 493-1h, 493-2h, 493-3h for selective positioning of the frame magnet (not shown) within the frame magnetic element housing 492h.

As another example, as shown in FIG. 14, a door magnetic element 480i may be provided with a mounting plate 481i secured to the door (not shown), for adjustable positioning of the housing 482i on the door when the housing is mounted to the mounting plate. As shown, the housing 482i may be provided with a plurality of interlocking portions 488i (e.g., apertures, sockets, etc.) for selective mounting to an interlocking portion 481-1i (e.g., post, pin, etc.) of the mounting plate 481i along a range of positions with respect to the mounting plate. Alternatively (not shown), the mounting plate may be provided with a plurality of interlocking portions for selective mounting of an interlocking portion of the housing along a range of positions with respect to the housing.

According to another exemplary aspect of the present disclosure, the door and the door frame may each be provided with a plurality of aligning, attractive magnetic elements positioned along the lateral width of the door to provide an incremental attractive force on the door towards the closed position as the door rotates from the open position to the closed position. When the door is in the partially open position, the door and door frame magnetic elements that are closer to the hinge side of the door are in closer proximity to each other than the door and door frame magnetic elements that are further from the hinge side of the door, such that these hinge proximal magnetic elements will apply an initial magnetic attractive force to rotate, or assist rotation of, the door further towards the closed position, to bring the hinge distal magnetic elements into closer proximity with each other for application of additional magnetic attractive force to further rotate the door towards the closed position. When the door is in the unlatched, nearly closed position, the combined attractive force of all of the sets of magnetic elements is sufficient to overcome the resistive forces of the closure resisting elements of the door system (e.g., spring-loaded latch and/or weatherstripping, as described above).

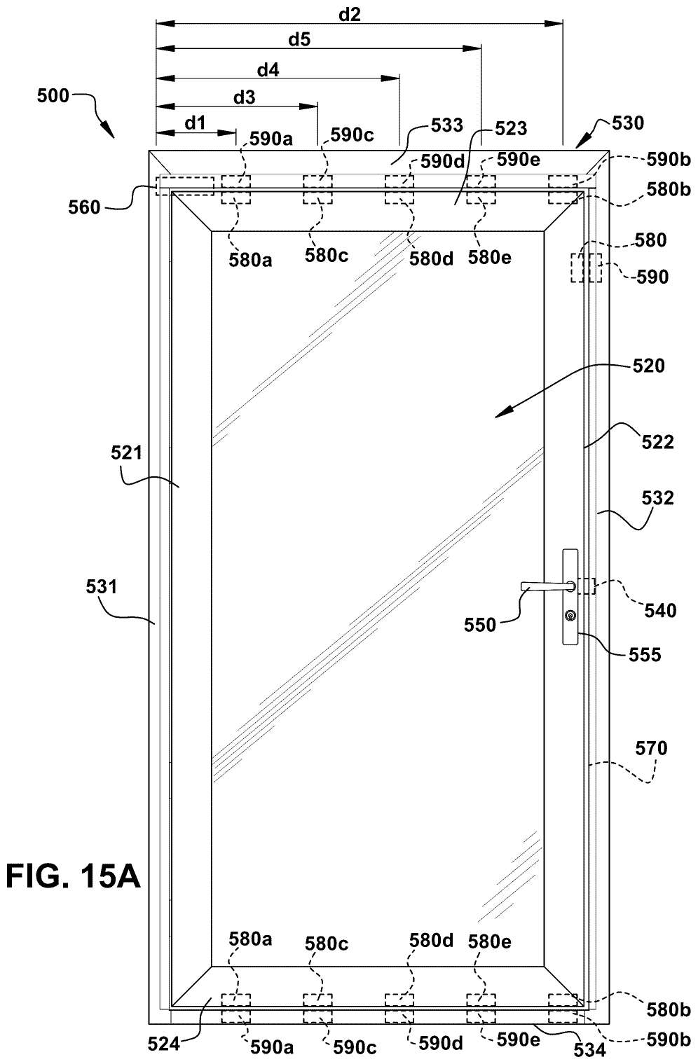

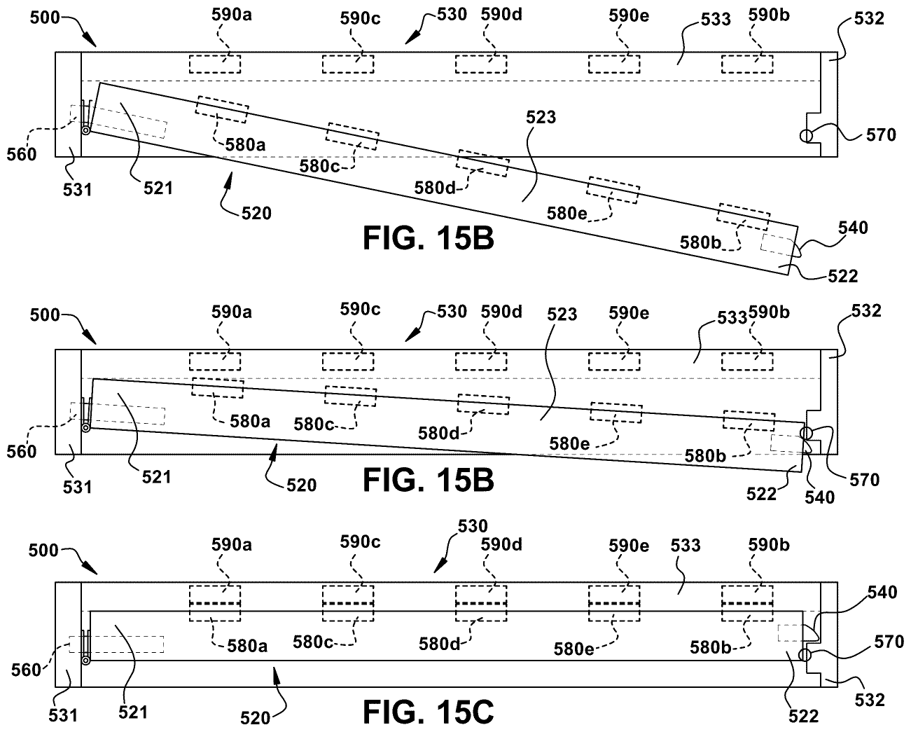

FIGS. 15A, 15B, 15C, and 15D schematically illustrate front and cross-sectional upper views of a door system 500 including a door 520 installed in a door frame 530, which may be similar to the door system 10 illustrated in FIGS. 1 and 2 and described above. The door frame 530 includes a vertically extending hinge-side jamb 531, a vertically extending latch-side jamb 532, a horizontally extending upper head 533, and a horizontally extending lower sill 534. The door 520 includes horizontally extending top and bottom ends 523, 524, a vertically extending hinge side 521 hingedly or pivotably attached to the hinge-side jamb 531 (e.g., by one or more hinge assemblies), and a vertically extending latch side 522 carrying a latching mechanism 540 for latching engagement with the latch-side jamb 532 when the door is in a closed position within the door frame 530. In the closed position, the top end 523 of the door 520 abuts the upper head 533 and the bottom end 524 of the door abuts the lower sill 534.

The door system 500 of FIGS. 15A-15D may include a latching mechanism 540, one or more weatherstripping elements 570, one or more handles 550, one or more locksets 555, and one or more door closers 560, which may, but need not, be similar to the components of the door system 10 illustrated in FIGS. 1 and 2 and described above.

As shown in FIG. 15A, the door system 500 includes a first set of magnetic elements 580a, 590a on the door 520 and door frame 530 at a first lateral distance d1 from the door hinge, and a second set of magnetic elements 580b, 590b on the door and door frame at a second lateral distance d2 from the door hinge, greater than the first distance or closer to the door latch side. The first door magnetic element 580a is disposed on or secured to one of the top end 523 and the bottom end 524, and the first frame magnetic element 590a is disposed on or secured to a corresponding one of the upper head 533 and the lower sill 534, at the first lateral distance d1. The second door magnetic element 580b is disposed on or secured to one of the top end 523, the bottom end 524, and the latch side 522 of the door 520, and the second frame magnetic element 590b is disposed on or secured to a corresponding one of the upper head 533, the lower sill 534, and the latch-side jamb 532 of the frame 530, at the second lateral distance d2.

When the door 520 is in a first, partially open position (FIG. 15B), the first set of magnetic elements 580a, 590a are in sufficient proximity (e.g., within about 1-2 inches) to each other to generate an initial or first magnetic attractive force M1 to assist movement of the door 520 towards the unlatched, nearly closed position. In this first position, the second set of magnetic elements 580b, 590b may not be in close enough proximity to each other to generate a significant magnetic attractive force.

In the unlatched, nearly closed position (FIG. 15C), the second set of magnetic elements 580b, 590b align and are in sufficient proximity to provide a second magnetic attractive force M2, with at least the first and second magnetic attractive forces M1, M2 being sufficient to overcome a resisting force R of at least one closure resisting element (e.g., spring-loaded latch 540, and/or weatherstripping 570) to move the door 520 from the unlatched nearly closed position to the closed position (FIG. 15D).

In some embodiments, the door system 500 may include one or more additional sets of magnetic elements 580c-e, 590c-e along the lateral width of the door (e.g., between the first and second sets of magnetic elements 580a-b, 590a-b), at incremental distances d3, d4, d5 from the door hinge side 521, to provide incrementally increasing magnetic attractive forces as the door rotates from the open position to the closed position, providing a type of “zipper” effect in drawing the door into the closed and latched position.

The plurality of door and frame magnetic elements may be positioned over a substantial lateral width of the door, for example, at least 50% of the lateral width of the door.

As shown in FIGS. 15A-15D, the magnetic elements 580a-e, 590a-e may be discrete components positioned at spaced apart locations along the lateral width of the door 520 and door frame 530. The discrete magnetic elements 580a-e, 590a-e may take a variety of attachment arrangements and forms, including, for example, the exemplary attachment arrangements of FIGS. 4-5D and the exemplary magnetic element assemblies of FIGS. 6-8A.

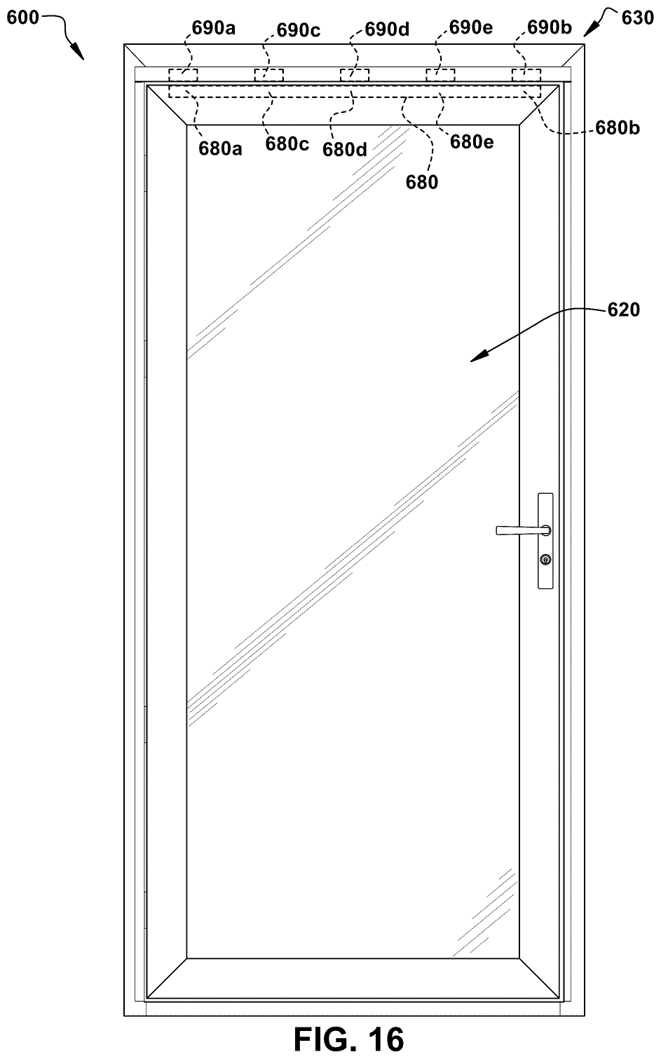

According to another exemplary aspect of the present disclosure, as schematically shown in FIG. 16, a door system 600 may include a door 620 having a unitary magnetic strip of material 680 (e.g., an elongated magnet or ferromagnetic strip) having a plurality of door magnetic portions 680a-e along its length for alignment with, and attraction to, discrete frame magnetic elements 690a-e on the door frame 630 for gradual, incremental magnetic attraction of the door to the closed, latched position, as described above.

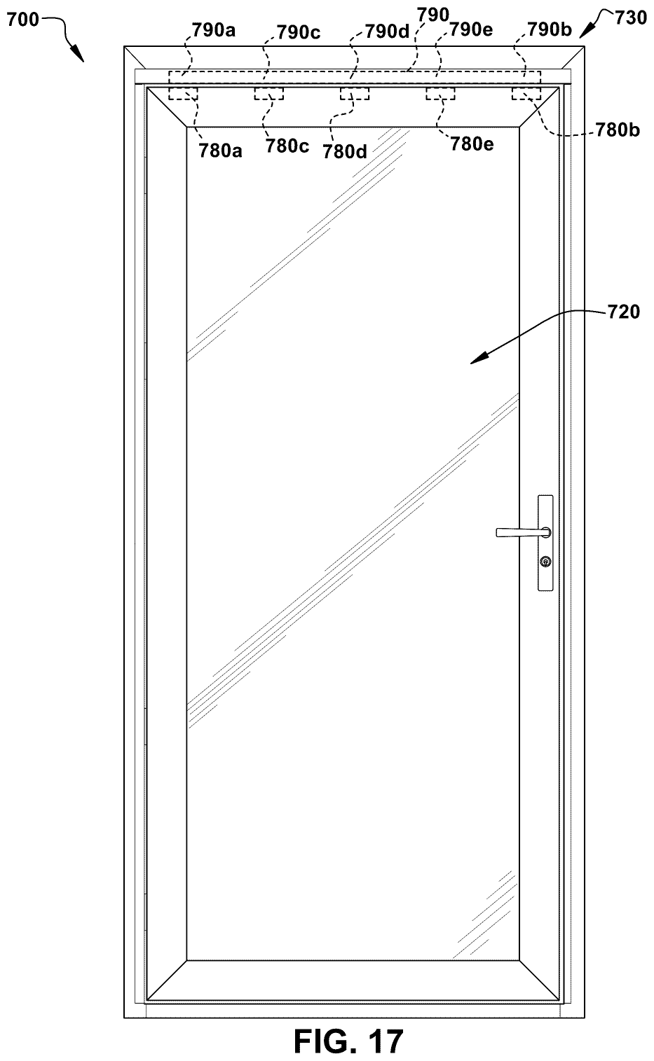

According to another exemplary aspect of the present disclosure, as schematically shown in FIG. 17, a door system 700 may include a door frame 730 having a unitary magnetic strip of material 790 (e.g., an elongated magnet or ferromagnetic strip) having a plurality of frame magnetic portions 790a-e along its length for alignment with, and attraction to, discrete door magnetic elements 780a-e on the door 720 for gradual, incremental magnetic attraction of the door to the closed, latched position, as described above.

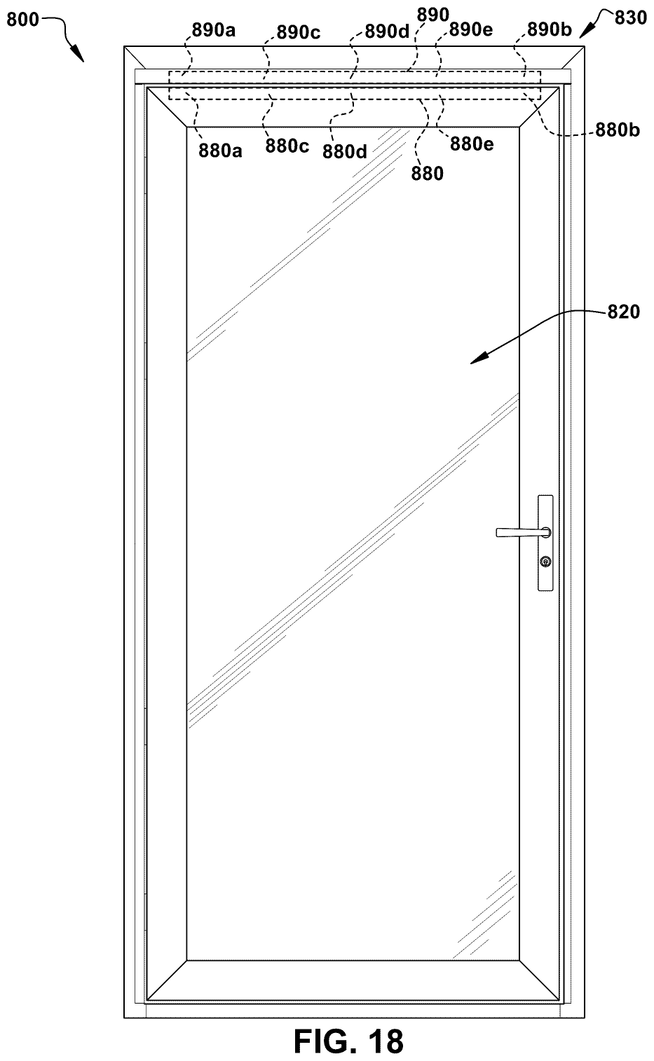

According to another exemplary aspect of the present disclosure, as schematically shown in FIG. 18, a door system 800 may include a door 820 having a unitary magnetic strip of material 880 (e.g., an elongated magnet or ferromagnetic strip) having a plurality of door magnetic portions 880a-e along its length for alignment with, and attraction to a plurality of frame magnetic portions 890a-e of a unitary magnetic strip of material 890 secured to the door frame 830 for gradual, incremental magnetic attraction of the door to the closed, latched position, as described above.

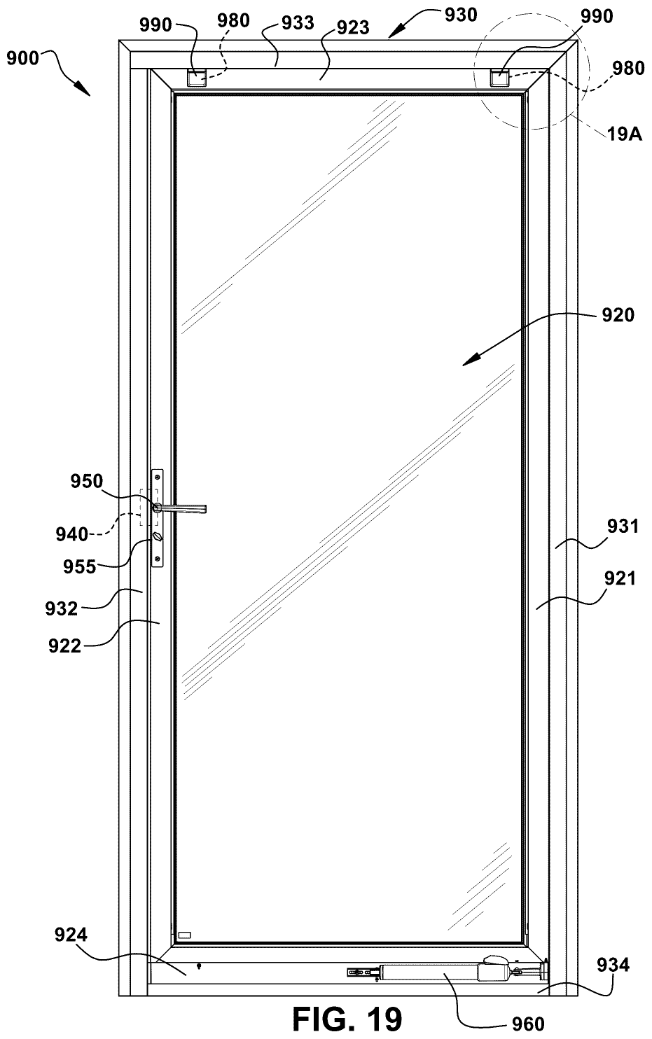

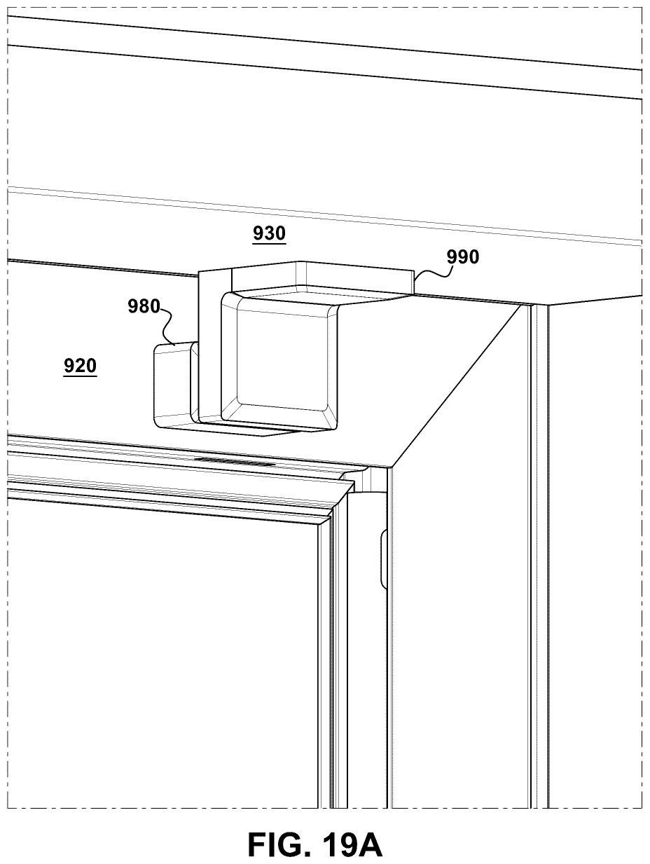

FIGS. 19 and 19A illustrate an exemplary door system 900 including a door 920 installed in a door frame 930, which may be similar to the door system 10 illustrated in FIGS. 1 and 2 and described above. The door frame 930 includes a vertically extending hinge-side jamb 931, a vertically extending latch-side jamb 932, a horizontally extending upper head 933, and a horizontally extending lower sill 934. The door 920 includes horizontally extending top and bottom ends 923, 924, a vertically extending hinge side 921 hingedly or pivotably attached to the hinge-side jamb 931 (e.g., by one or more hinge assemblies), and a vertically extending latch side 922 carrying a latching mechanism (shown schematically at 940) for latching engagement with the latch-side jamb 932 when the door is in a closed position within the door frame 930. In the closed position, the top end 923 of the door 920 abuts the upper head 933 and the bottom end 924 of the door abuts the lower sill 934.

The exemplary door 920 includes one or more handles 950, one or more locksets 955, and one or more door closers 960, which may, but need not, be similar to the components of the door system 10 illustrated in FIGS. 1 and 2 and described above. As shown, the door closer 960 may be provided at the bottom end of the door 920, for example, to better accommodate the magnetic elements, as described below.

The door system 900 includes first and second door magnetic elements 980a, 980b and first and second frame magnetic elements 990a, 990b. A variety of suitable magnetic elements may be used, such as, for example, any of the exemplary magnetic elements described herein. As evident in FIG. 19A, the door magnetic elements 980a, 980b may comprise a block-shaped magnet retaining module, similar to the door magnetic element 480d of FIGS. 9 and 9A, and the frame magnetic elements 990a, 990b may comprise a flanged magnet retaining module, similar to the frame magnetic element 490d of FIGS. 9 and 9A.

The first set of magnetic elements includes a first door magnetic element 980a secured to the top end 923 of the door 920 and a first frame magnetic element 990a secured to the upper head 933 of the door frame 930, each at a first lateral distance d1 from the door hinge. The second set of magnetic elements includes a second door magnetic element 980b secured to the top end 923 of the door 920 and a second frame magnetic element 990b secured to the upper head 933 of the door frame 930, each at a second lateral distance d2 from the door hinge, greater than the first distance d1 or closer to the door latch side. The lateral distance between the first and second door magnetic elements may be substantially spaced apart, for example, by at least 50% of a lateral width of the door. In an exemplary embodiment, the first lateral distance d1 from the door hinge to the first magnet set center line is less than about ¼ of the lateral width of the door, or approximately ⅛ of the lateral width of the door, and the second lateral distance d2 from the door hinge to the second magnet set center line is greater than about ¾ of the lateral width of the door, or approximately ⅞ of the lateral width of the door.

When the door 920 is in a first, partially open position (not shown, but similar to the configuration of FIG. 15B), the first set of magnetic elements 580a, 590a are in sufficient proximity (e.g., within about 1-2 inches) to each other to generate an initial or first magnetic attractive force to assist movement of the door 220 towards the unlatched, nearly closed position. In this first position, the second set of magnetic elements 980b, 990b may not be in close enough proximity to each other to generate a significant magnetic attractive force.

In the unlatched, nearly closed position (not shown, but similar to the configuration of FIG. 15C), the second set of magnetic elements 980b, 990b align and are in sufficient proximity to provide a second magnetic attractive force, with at least the first and second magnetic attractive forces being sufficient to overcome a resisting force of at least one closure resisting element (e.g., spring-loaded latch, weatherstripping, dampening door closer, air pressure between the door and a second door) to move the door 920 from the unlatched nearly closed position to the closed position.

The plurality of door and frame magnetic elements may be positioned over a substantial lateral width of the door, for example, at least 50% of the lateral width of the door.

As shown in FIGS. 15A-15D, the magnetic elements 580a-e, 590a-e may be discrete components positioned at spaced apart locations along the lateral width of the door 520 and door frame 530. The discrete magnetic elements 580a-e, 590a-e may take a variety of attachment arrangements and forms, including, for example, the exemplary attachment arrangements of FIGS. 4-5D and the exemplary magnetic element assemblies of FIGS. 6-8A.

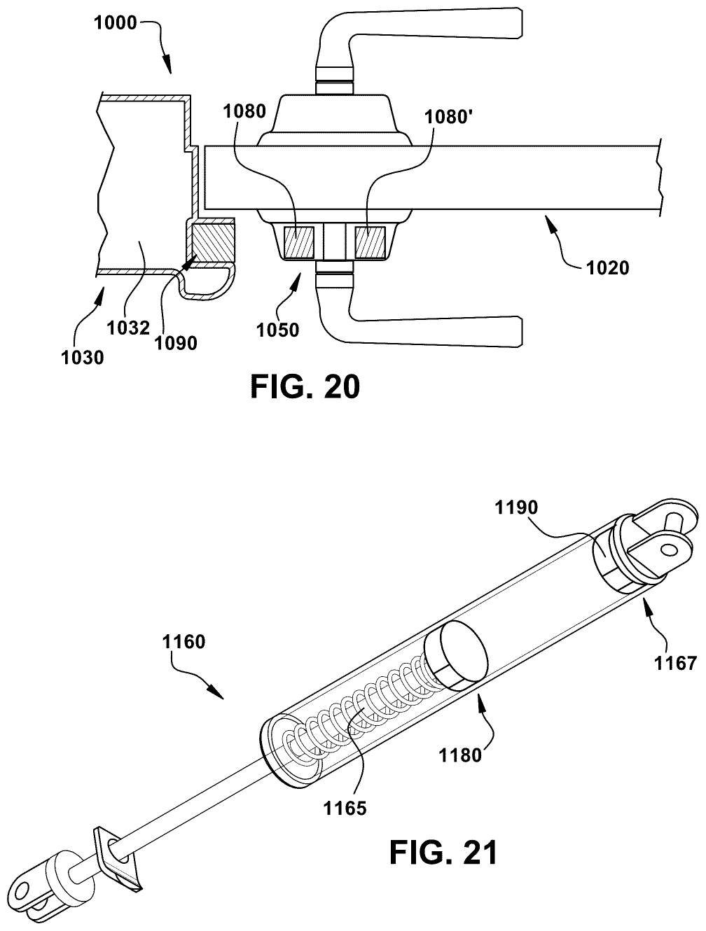

In other embodiments, door and frame magnetic elements may be connected to or otherwise provided with the door and the door frame using other configurations. For example, as shown in FIG. 20, a door system 1000 may include a door 1020 having a door magnetic element 1080 secured to the door handle 1050, and a door frame 1030 including a frame magnetic element 1090 secured to the latch-side jamb 1032 of the door frame (e.g., on or adjacent to the strike plate) for alignment with the door magnetic element and magnetic attraction of the door from the unlatched, nearly closed position to the closed latched position, as described herein. In one such embodiment, a second door magnetic element 1080′, having the same polarity as the frame magnetic element 1090, may be secured to the door handle 1050 for alignment with the frame magnetic element when the door handle is rotated from a latching position (retaining the latch element in latching engagement with the latch recess) to an unlatching position (effective to retract the latch element from the latch recess), thereby providing a repulsive force between the frame magnetic element and the second door magnetic element, to assist movement of the door 920 towards an open position.

As another example, as shown in FIG. 21, a door system may be provided with a door closer 1160 (e.g., a fluid dampened door closer) having a closer arm 1165 secured to one of the door and the door frame (not shown) and a closer cylinder 1167 secured to the other of the door and the door frame. A first magnetic element 1180 is secured to the closer arm 1165 (e.g., at a piston portion) and a second magnetic element 1190 is secured to the closer cylinder 1167. When the door is in the unlatched, nearly closed position, the first and second magnetic elements 1180, 1190 are in alignment or proximity to provide an attractive force sufficient to overcome the closure resisting force to move the door from the unlatched nearly closed position to the closed position for latching engagement of the latch element with the latch recess.

While various aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1. A door system comprising:
a door frame including a vertically extending hinge-side jamb, a vertically extending latch-side jamb, a horizontally extending upper head, and a horizontally extending lower sill;
a door having a vertically extending hinge side hingedly attached to the hinge-side jamb, a vertically extending latch side abutting the latch-side jamb when the door is in a closed position, a horizontally extending top end abutting the upper head when the door is in the closed position, and a horizontally extending bottom end abutting the lower sill when the door is in the closed position; and
a latch element assembled with the door and extendable from the latch side of the door for latching engagement with a latch recess in the latch-side jamb when the door is in the closed position;
wherein when the door is in an unlatched nearly closed position, the door is subjected to a closure resisting force to resist movement of the door to the closed position;
wherein the door includes at least one door magnetic element and the door frame includes at least one frame magnetic element for alignment with the at least one door magnetic element when the door is in the unlatched nearly closed position, such that the at least one door magnetic element and the at least one frame magnetic element provide an attractive force sufficient to overcome the closure resisting force to move the door from the unlatched nearly closed position to the closed position for latching engagement of the latch element with the latch recess.

2. The door system of claim 1, wherein the at least one door magnetic element is secured to one of the latch side, the top end, and the bottom end of the door, and the at least one frame magnetic element is secured to a corresponding one of the latch-side jamb, the upper head, and the lower sill.

3. The door system of claim 2, wherein the at least one door magnetic element comprises a first door magnetic element disposed on one of the top end and the bottom end and spaced apart from the hinge side at a first lateral distance and a second door magnetic element disposed on one of the top end, the bottom end, and the latch side and spaced apart from the hinge side at a second lateral distance greater than the first lateral distance.

4. The door system of claim 3, wherein a lateral distance between the first and second door magnetic elements is at least 50% of a lateral width of the door.

5. The door system of claim 3, wherein the at least one frame magnetic element comprises a first frame magnetic element disposed on a corresponding one of the upper head and the lower sill for alignment with the first door magnetic element, and a second frame magnetic element disposed on a corresponding one of the upper head, the lower sill, and the latch-side jamb for alignment with the second door magnetic element.

6. The door system of claim 3, wherein the at least one door magnetic element further comprises at least one additional door magnetic element laterally positioned between the first and second door magnetic elements.

7. The door system of claim 1, wherein the at least one frame magnetic element comprises a first frame magnetic element disposed on one of the upper head and the lower sill and spaced apart from the hinge side at a first lateral distance and a second frame magnetic element disposed on one of the upper head, the lower sill, and the latch-side jamb and spaced apart from the hinge side at a second lateral distance greater than the first lateral distance.

8. The door system of claim 7, wherein a lateral distance between the first and second frame magnetic elements is at least 50% of a lateral width of the door.

9. The door system of claim 7, wherein the at least one door magnetic element comprises a first door magnetic element disposed on a corresponding one of the top end and the bottom end for alignment with the first frame magnetic element, and a second door magnetic element disposed on a corresponding one of the top end, the bottom end, and the latch side for alignment with the second frame magnetic element.

10. The door system of claim 7, wherein the at least one frame magnetic element further comprises at least one additional frame magnetic element laterally positioned between the first and second frame magnetic elements.

11. The door system of claim 1, wherein the at least one door magnetic element is disposed in a cavity within the door.

12. The door system of claim 1, wherein the at least one door magnetic element is secured to one of an edge surface of the door and a rear surface of the door.

13. The door system of claim 1, wherein the at least one frame magnetic element is disposed in an internal channel within the door frame.

14. The door system of claim 1, wherein the at least one frame magnetic element is secured to an exterior surface of the frame.

15. The door system of claim 1, wherein the at least one frame magnetic element is disposed on a flange portion extending into alignment with the door.

16. The door system of claim 1, wherein at least one of the at least one door magnetic element and the at least one frame magnetic element comprises a housing secured to a mounting surface of the corresponding one of the door and the door frame and enclosing an interior magnet.

17. The door system of claim 1, wherein the at least one door magnetic element and the at least one frame magnetic element include attractive surfaces that extend in a transverse direction, such that the attractive surfaces of the at least one door and frame magnetic elements move into sliding abutment with each other as the door is transversely rotated from the open position to the nearly closed position.

18. The door system of claim 1, wherein the at least one door magnetic element and the at least one frame magnetic element include attractive surfaces that extend in at least one of a longitudinal direction and a lateral direction, such that the attractive surfaces of the at least one door and frame magnetic elements move into facing abutment with each other as the door is transversely rotated from the open position to the nearly closed position.

19. The door system of claim 1, wherein the at least one door magnetic element and the at least one frame magnetic element provide an attractive force when the at least one door magnetic element and the at least one frame magnetic element are spaced apart by a distance of between about 1 inch and about 2 inches.

20. A door system comprising:
a door frame including a vertically extending hinge-side jamb, a vertically extending latch-side jamb, a horizontally extending upper head, and a horizontally extending lower sill;
a door having a vertically extending hinge side hingedly attached to the hinge-side jamb, a vertically extending latch side abutting the latch-side jamb when the door is in a closed position, a horizontally extending top end abutting the upper head when the door is in the closed position, and a horizontally extending bottom end abutting the lower sill when the door is in the closed position; and
a latch element assembled with the door and extendable from the latch side of the door for latching engagement with a latch recess in the latch-side jamb when the door is in the closed position;
wherein the door includes at least first and second door magnetic element disposed on at least one of the top end, the bottom end, and the latch side at smaller first and greater second lateral distances from the hinge side, and the door frame includes at least first and second frame magnetic element disposed on corresponding ones of the upper head, the lower sill, and the latch-side jamb for alignment with the first and second door magnetic elements at least when the door is in the closed position;
wherein when the door is in a first, partially open position, the first door and frame magnetic elements apply a first magnetic attractive force to assist rotation of the door towards an unlatched, nearly closed position; and
wherein when the door is in the unlatched, nearly closed position, each of the at least first and second door and frame magnetic elements apply a combined magnetic attractive force to cause the door to move from the unlatched, nearly closed position to the closed position.
